(19) United States
(12) Patent Application Publication
(10) Pub. No.: US 2011/0171115 A1
(43) Pub. Date: Jul. 14, 2011

(54) Method and Consolidated Apparatus for Recovery of Sulfur from Acid Gases

(75) Inventors: David K. Stevens, Prairie Village, KS (US); Mark R. Tonjes, Lenexa, KS (US); Lindsay D. Dreitzler, Overland Park, KS (US); Alan D. Mosher, Overland Park, KS (US)

(73) Assignee: KPS TECHNOLOGY & ENGINEERING LLC, Overland Park, KS (US)

(21) Appl. No.: 12/840,773

(22) Filed: Jul. 21, 2010

Related U.S. Application Data
(60) Provisional application No. 61/227,568, filed on Jul. 22, 2009.

(51) Int. Cl. C01B 17/04; B01J 8/00

(52) U.S. Cl. 423/574.1; 422/187

(57) ABSTRACT

An improved method and consolidated apparatus for recovery of sulfur from acid gases using the modified-Claus process and Claus tail gas treating process of the hydrogenation/amine absorption type as classically practiced in the oil & gas industry. By implementing innovations to the acid gas processing strategy a wider range of feedstocks can be processed and improved performance is seen when processing conventional feedstocks; in addition, through consolidation and integration of the typical practice an improved apparatus is realized.

### RELATED APPLICATION

The present non-provisional patent application is related to and claims priority benefit of an earlier-filed provisional patent application titled METHOD AND CONSOLIDATED APPARATUS FOR RECOVERY OF SULFUR FROM ACID GASES, Ser. No. 61/227,568, filed 22 Jul. 2009. The identified earlier-filed application is hereby incorporated by reference into the present application.

### FIELD OF THE INVENTION

The present invention relates to an improved method for the recovery of sulfur from acid gases using the modified-Claus process with the Claus tail gas treating process of the hydrogenation/amine absorption type as classically practiced in the oil & gas industry. By implementing innovations to the acid gas processing strategy a wider range of feedstocks can be processed and improved performance is seen when processing conventional feedstocks; in addition, through modification, consolidation and integration of the conventional practice an improved apparatus is realized.

### BACKGROUND OF THE INVENTION

The modified-Claus process for recovery of elemental sulfur from acid gases is in widespread use throughout the oil & gas industry. It is a very well-known process and quite familiar to those practiced in the art. In order to control the sulfur emissions to the atmosphere a stand-alone modified-Claus sulfur recovery unit (SRU) is normally not sufficient to meet most environmental regulations. To further the overall sulfur recovery, the addition of a Claus tail gas treating unit of the hydrogenation/amine absorption type has now become an industry standard. A tail gas treating unit (TGTU) is nearly always required to meet overall sulfur emission requirements.

The traditional industrial approach is to treat the modified-Claus SRU and the downstream TGTU as two segregated operating units. However, given that environmental regulations are becoming more stringent with respect to sulfur emissions, it is becoming a requirement to operate both the SRU and TGTU all of the time. Thus, the present invention is a consolidation of the SRU and TGTU into a single integrated unit with new design features. This consolidated approach results in a novel process described as an Acid Gas Conversion Unit (AGCU).

The AGCU was developed in response to the industry requirement for higher reliabilities and availabilities to meet environmental regulations. In former times it was permissible to flare acid gases when the SRU was down. Today both the SRU and TGTU are required to operate together all of the time as SRU only operation or acid gas flaring is not allowed. The requirement of continuous online acid gas processing for sulfur recovery results in redundancy of the SRU and TGTU. This, of course, results in substantial investment cost as multiple SRUs and TGTUs are now required. It was noticed that from past practice of SRU and TGTU design that certain normal practices to allow operating flexibility and reliability for single SRU and TGTU are repeated in the time when redundant units were now being required. The AGCU eliminates these single unit design margins and results in an acceptable design margin for the redundant situation.

In addition to the above mentioned consolidated approach, the AGCU has implemented new acid gas processing strategies to provide a wider range of flexibility in handling problematic acid gases. These include very lean (low hydrogen sulfide content) acid gases and acid gases with contaminants such as mercaptan and BTEX (aromatic hydrocarbons). There have been an increased number of such applications as more sour gas fields are being developed and many coal and coke gasification facilities are being constructed. In addition to the innovative acid gas processing strategy, additional improvements to improve operation are incorporated in the AGCU. For example, the use of a combination of packing and trays in the Amine absorber section to minimize the amount of carbon dioxide pickup and maximize the removal of hydrogen sulfide. This improves environmental protection at the same time as improving the operability of the Claus thermal reactor.

The AGCU represents an improved method for sulfur recovery from acid gases and represents the lowest complexity factor by consolidation and integration while still meeting the conventional SRU and TGTU environmental emission standards.

### SUMMARY OF THE INVENTION

The present invention considers the modified-Claus sulfur recovery unit and downstream tail gas treating unit as an integrated whole. The integration strategies result in a much smaller processing unit, while achieving the same level of sulfur recovery efficiency.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one part of the invention in detail, it is to be understood that the invention is not limited in its application to the details of construction or to the arrangements of the components set forth in the following description. The invention is capable of other embodiments and of being practiced and carried out in various ways. Also, it is to be understood that the phraseology and terminology employed herein are for the purpose of the description and should in no way be limiting.

The AGCU is a tightly integrated processing unit that consists of a series of individual sections:
a. a Claus Thermal Reaction section for combusting one-third of the acid gas H₂S to SO₂ and thermally promoting the Claus Reaction;
b. a Claus Catalytic Reaction section for catalytically continuing the Claus Reaction and recovering the produced sulfur;
c. a Hydrogenation section for generating reducing gas and hydrogenating the tail gas from the Claus Reaction section;
d. a Quench section for cooling the hydrogenated tail gas;
e. an Amine section for recovering the H₂S from the quenched tail gas and;
f. an Incineration section for incinerating the tail gases prior to discharge to the atmosphere.

While the AGCU represents a proven design concept based upon conventional practice the following features of the AGCU process illustrate the uniqueness of the process:

### Claus Catalytic Section Reduced to Single Stage

In a conventional Claus sulfur recovery unit, two or more catalytic stages are provided downstream of the Thermal Reaction Section. The present invention employs only one Claus catalytic stage, wherein the reaction of H₂S and SO₂ leaving the Thermal Reaction stage continues at lower temperature. Due to the single catalytic stage, one or more Claus Reactors, one or more Sulfur Condensers, and two or more reheat devices are removed compared to prior art.

### Recycle of Regenerator Acid Gas to Claus Reactor

Prior art recycled the acid gas from the amine regenerator to the front end of the SRU. The present invention routes this recycle stream just upstream of the Claus Reactor. This achieves a higher temperature in the Thermal Reaction Section. Better flame stability and sulfur conversion are achieved at the elevated temperature in the Thermal Reactor. Carbonyl Sulfide (COS) generation in the Thermal Reactor is also reduced. In most applications, the entire acid gas recycle stream will be routed to the Claus Reactor. Design variations may include splitting this stream between the Acid Gas KO Drum and the Claus Reactor.

### Combination of Packing and Trays in Amine Absorber/Multiple Feed Points in Absorber

The present invention minimizes the amine (including, but not limited to MDEA) circulation rate by optimizing the Amine Absorber internals. The Acid Gas Conversion Unit Absorber contains one of more packed beds as well as two or more trays. Multiple feed points are provided for flexibility and ensuring the most selective gas treating for a given feed composition (removing H₂S, rejecting CO₂).

Many Equipment Items are Consolidated into Shared “Shells”

While those skilled in the art of sulfur recovery units are familiar with combining equipment in small to mid-sized units (i.e., combined sulfur condensers or combined Claus reactors), the present invention takes this consolidation to another level. The services that were once segregated to the SRU and TGTU are now consolidated. The present invention combines the single Claus Reactor and Hydrogenation Reactor in a common shell. It also combines the Sulfur Condensers and Hydrogenation Waste Heat Exchanger (if required) into a common heat exchanger. In addition, the Quench and Absorber towers are stacked or combined. The use of combined shells and stacked equipment reduces the capital cost of the equipment as well as the required plot space.

### Single Pass Waste Heat Exchanger Optimized for Both Bypass Reheat and Heat Recovery

The outlet temperature of the single pass Thermal Reactor Waste Heat Exchanger is carefully chosen for the present invention. This allows economic heat recovery from the Thermal Reactor effluent in the form of steam generation, while maintaining a hot enough process stream to provide bypass reheat. A slipstream of hot gas from the Waste Heat Exchanger is mixed with the 1^{st} Sulfur Condenser effluent and the amine section acid gas to achieve the desired inlet temperature to the Claus Reactor. This removes the requirement for a reheat device in this section.

Other objects and advantages of the present invention will become obvious and it is intended that these objects are within the scope of the present invention. To the accomplishment of the above and related objects, this invention may be embodied in the form illustrated in the accompanying drawing, attention being called to the fact, however, that the drawing is illustrative only, and that changes may be made in the specific construction illustrated and described within the scope of this application.

### BRIEF DESCRIPTION OF THE DRAWINGS

Various other objects, features, and attendant advantages of the present invention will become fully appreciated as the same becomes better understood when considered in conjunction with the accompanying drawings.

FIG. 1 is a block flow diagram of an Acid Gas Conversion Unit in accordance with the present invention.

FIG. 2 is a block flow diagram of a modified embodiment of the Acid Gas Conversion Unit.

FIG. 3 is a block flow diagram of a further modified embodiment of the Acid Gas Conversion Unit.

FIG. 4 is a block flow diagram of a further modified embodiment of the Acid Gas Conversion Unit.

FIG. 5 is a block flow diagram of a further modified embodiment of the Acid Gas Conversion Unit.

FIG. 6 is a graph designated as “Table 3—AGCU Effect on Combustion Temperature and BTEX Destruction.”

FIG. 7 is a graph designated as “Table 4—COS Production in Thermal Stage.”

### DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In the discussion of the drawings, not all components required for operation of the invention are shown.

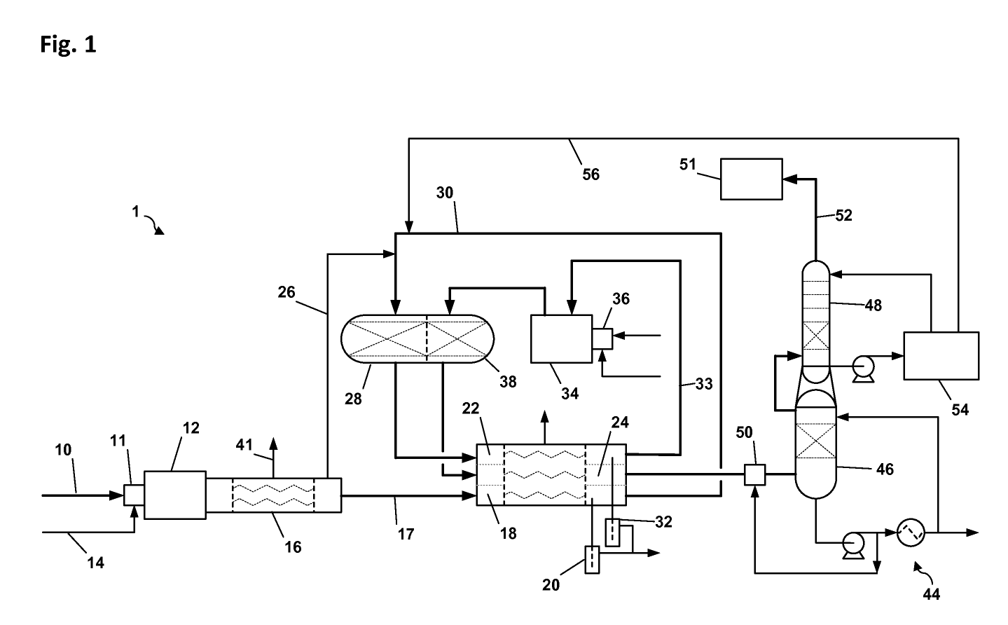

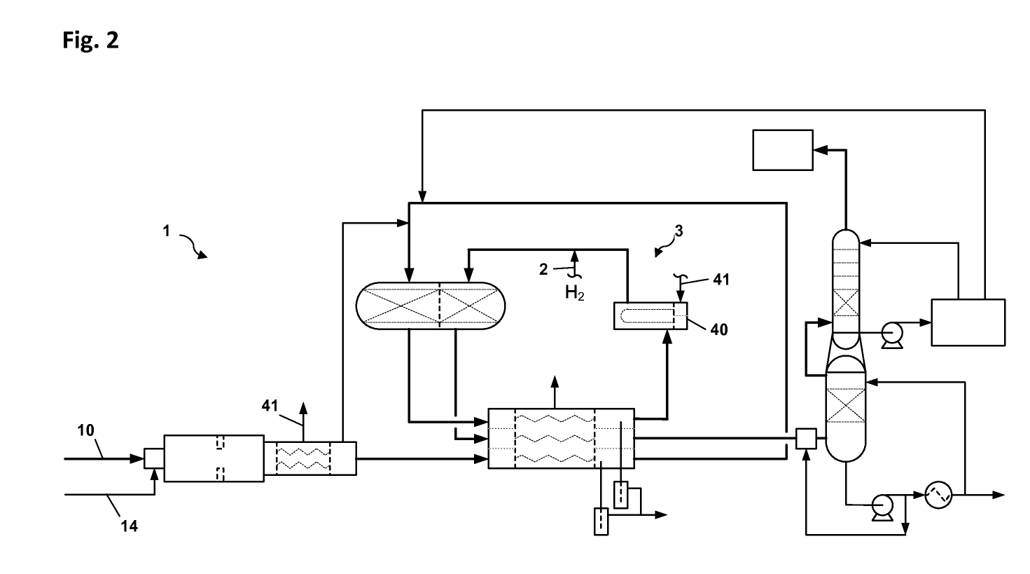

Turning now descriptively to the drawings, FIG. 1 illustrates an acid gas conversion unit system 1 (“AGCU”) for converting acid gas into water and elemental sulfur that consolidates the conventional modified-Claus sulfur recovery process and downstream tail gas treating process into an integrated whole. The basic concept of the ACGU 1 is shown in its two basic forms in FIGS. 1 and 2. In FIG. 1, the AGCU 1 is shown for those applications where no source of external hydrogen exists and a method for generation of reducing gases is required. Whereas FIG. 2 is shown for those applications where a source of external hydrogen 2 exists for a Hydrogenation section 3. The figures illustrate how the AGCU 1 consolidates a modified-Claus sulfur recovery unit (“SRU”) and downstream tail gas treating unit (“TGTU”) into an integrated whole. The integration strategies result in a much smaller processing unit, while maintaining the same level of sulfur recovery efficiency. The present invention is a consolidated processing unit that consists of a series of individual sections which involve design innovations. Those sections are described below.

### Claus Thermal Reaction

An acid gas feedstock 10 first passes though an Acid Gas KO Drum (not shown) to remove any entrained water and/or amine carryover. This prevents damage to a Burner 11 and refractory in a downstream Thermal Reactor 12. If the application is in a refinery there is often a second acid gas, sour water stripper gas, which in addition to hydrogen sulfide also contains ammonia.

Air is supplied via Line 14 to Burner 11 by Combustion Air Blowers (not shown). The air flow to Burner 11 is regulated to ensure the complete oxidation of all feed gas hydrocarbons and to combust one-third of the H₂S as required, obtaining a controlled H₂S to SO₂ ratio in the downstream tail gas.

In the modified Claus process, one third of the H₂S in the feed gas stream 10 is burned to form sulfur dioxide (SO₂). The resulting SO₂ then reacts with the balance of the H₂S to form elemental sulfur (Sₙ) and water (H₂O) in the vapor phase.

H₂S+3/2O₂→SO₂+H₂O

2H₂S+SO₂→2H₂O+3/nSₙ

The main parameters to achieve the highest sulfur recovery efficiency in the thermal reaction section are combustion temperature, gas mixing and residence time. In the AGCU process, the acid gas from the amine section is recycled just upstream of the Claus Reactor. This produces an increase in the Thermal Reactor temperature compared to the conventional approach of recycling the amine section acid gas to the Acid Gas KO Drum and mixing with the acid gas feedstock 10. Better flame stability and Claus conversion are thus achieved at the elevated temperature. Carbonyl sulfide, an undesirable byproduct formed in the Claus Thermal Reactor 12 during combustion, is also reduced by the elevated temperature obtained by AGCU process.

Hot gas exits the Thermal Reactor 12 through a directly connected Waste Heat Exchanger 16 in which the gas is on the tube side. Saturated high pressure (HP) steam (between 300 and 700 psig) is produced in the single pass Waste Heat Exchanger 16 while cooling the process gas. The bulk of the Waste Heat Exchanger 16 effluent is routed via line 17 to a 1^{st} Sulfur Condenser 18 to further cool the gas and remove the sulfur converted in the thermal stage. Liquid sulfur is gravity drained to a Sulfur Pit (not shown) via a 1^{st} Sulfur Seal Pot 20. Low pressure (LP) steam (30 to 70 psig) is generated in the 1^{st} Sulfur Condenser 18, which shares a common shell with a 2^{nd} Sulfur Condenser 22 and Hydrogenation Waste Heat Exchanger 24. A slipstream line 26 of hot gas is bypassed around the 1^{st} Sulfur Condenser 18 to heat the gas entering a Claus Reactor 28. It is noted that in the case of leaner acid gases there is insufficient sulfur produced in the Thermal Reactor 12 to implement the 1^{st} Sulfur Condenser 18. An additional note is that in small plants in may not be cost-effective to implement a Hydrogenation Waste Heat Exchanger 24 and thus, all the gas cooling is accomplished in the Quench section (described below).

The relative equipment sizes of the Acid Gas KO Drum, Thermal Reactor Burner 11, and Thermal Reactor 12 are consistent with a conventional SRU-TGTU approach. The Waste Heat Exchanger 16 has lower surface area due to the single pass approach and higher outlet temperature. The 1^{st} Sulfur Condenser 18 also has a reduced surface area compared to a traditional SRU-TGTU and reduced capital expense is realized due to the common shell with the 2^{nd} Sulfur Condenser 22 and Hydrogenation Waste Heat Exchanger 24.

### Claus Catalytic Reaction

To obtain additional recovery, the thermal section is followed by the catalytic reaction section. The Claus reaction of the remaining SO₂ and H₂S continues at lower temperature in the single Claus Reactor containing any commercially-available Claus catalyst.

2H₂S+SO₂→2H₂O+3/nSₙ

The slipstream of hot gas via line 26 from the Waste Heat Exchanger 16 is mixed with the 1^{st} Sulfur Condenser 18 effluent and the amine section acid gas in line 30 to achieve the desired inlet temperature to the Claus Reactor 28. This removes the requirement for an additional reheat exchanger. The conversion reaction in the Claus Reactor 28 improves as the inlet temperature is lowered. However, the reactor temperature must remain safely above the sulfur dew point temperature to avoid condensing sulfur in the catalyst pores, thereby deactivating the catalyst.

The temperature in the Claus Reactor 28, lower than that in the Thermal Reactor 12, allows the exothermic Claus reaction to approach equilibrium. The sulfur produced by this reaction is cooled and condensed in the 2″^{d} Sulfur Condenser 22 before draining to the Sulfur Pit via a 2^{nd} Sulfur Seal Pot 32. Low pressure steam is generated in the Sulfur Condensers 18 and 22.

The Claus Reactor 28 is slightly larger than a 1^{st} Claus Reactor in a traditional SRU-TGTU, but major capital savings are realized due to the single Catalytic Stage. An entire Claus Reactor, Sulfur Condenser, and two indirect reheaters are removed with the integrated Acid Gas Conversion Unit. The single Claus Reactor is also optimized by sharing a common shell with the downstream Hydrogenation Reactor.

### Hydrogenation

The Claus tail gas from the 2″^{d} Sulfur Condenser 22 flows to the hydrogenation section 3 via line 33 for reduction of all sulfur bearing compound to hydrogen sulfide (H₂S). The tail gas is heated up to reaction temperature in an Inline Burner Mixer 34 by mixing it with hot combustion products from a Reducing Gas Generator 36. The reducing gas (H₂ and CO) is available in the tail gas itself and is also generated in the Reducing Gas Generator 36. The reduction reactions take place in a catalyst bed (not shown) in a Hydrogenation Reactor 38, which shares a common shell with the Claus Reactor 28. It is noted that in applications where a source of external hydrogen is available, as shown in FIG. 2, it is preferable to use an indirect High Pressure Steam Heater 40 in lieu of the Inline Burner Mixer 34. High pressure steam may be provided from the Waste Heat Exchanger 16 via line 41.

The main hydrogenation reactions are given below. These reactions go nearly to completion.

SO₂+3H₂→H₂S+2H₂O

S+H₂→H₂S

A portion of the tail gas carbonyl sulfide and carbon disulfide are also hydrolyzed.

COS+H₂O→H₂S+CO₂

CS₂+2H₂O→2H₂S+CO₂

Each of these reactions is exothermic, generating a temperature rise in the Hydrogenation Reactor 38 catalyst bed. The Hydrogenation Reactor 38 effluent is cooled in the Hydrogenation Waste Heat Exchanger 24. The Hydrogenation Waste Heat Exchanger 24 shares a common shell with the Sulfur Condensers 18 and 22, another example of the integration of the Acid Gas Conversion Unit 1. The relative size of the Reducing Gas Generator 36 and Mixer 34 is unchanged from a traditional SRU-TGTU approach. Capital savings are realized in the common reactor shell arrangement of the AGCU Claus and Hydrogenation Reactors 28 and 38.

### Quench Section

Hot effluent from the Hydrogenation Reactor 38 flows through the Hydrogenation Waste Heat Exchanger 24 to a Quench section 44 which includes a Quench Tower 46 so that the gas can be cooled prior to amine treatment in a downstream Absorber 48. The hot effluent is initially cooled with an injection of quench water via a Quench Desuperheater 50. The desuperheated tail gas flows from the Quench Desuperheater 50 to the Quench Tower 46 for further cooling via contact with circulating quench water. The excess water that is condensed from the tail gas will contain H₂S and is exported via level control.

The AGCU Quench Section 44 results in a reduced Quench Tower 46 height due to the reduced number of theoretical stages required to cool the gas and condense out water as the Quench Desuperheater 50 functions as an additional stage. The plot footprint is reduced by combining the Quench Tower 46 and Absorber 48.

### Tail Gas Absorption

Cooled tail gas from the Quench Tower flows to the Absorber 48 for removal of the bulk of the H₂S with amine solvent. The H₂S is removed by selectively treating with amine solvent in the Absorber 48. Selective treating involves quick contact of the gas with cold solvent allowing the solvent to pick-up nearly all the H₂S, while rejecting as much CO₂ as possible. Cool lean amine enters the top of the Absorber 48 and counter-currently contacts the tail gas. The treated gas exits out the Absorber 48 overheads and flows to an Incinerator 51 via line 52. The H₂S-laden rich amine from the Absorber 48 bottoms is pumped to an Amine Regenerator 54 for recovery of the H₂S.

The main overall reactions occurring in the Absorber 48 are:

H₂S+R₃N→R₃NH⁺+HS⁻

CO₂+R₃N+H₂O→R₃NH⁺+CO3⁻
Where R₃ may be methyl-diethanol amine (MDEA)

The H₂S reaction is much faster than the CO₂ reaction, especially at lower operating temperatures. Minimizing the solvent temperature allows more CO₂ to slip out the Absorber 48 overheads and also minimize the solvent circulation rate. The AGCU Absorber 48 internals have been optimized to allow flexibility in the feed location, thereby ensuring the most selective treating for a given gas composition. The Absorber 48 contains one or more packed beds and 2 or more trays and is stacked with the Quench Tower 46 to obtain the smallest plot footprint.

The solvent is regenerated by steam-stripping the H₂S and CO₂ from the rich solvent from the Absorber 48 in the Amine Regenerator 54. The steam is provided by boiling the solvent with the heat provided first by feed/bottoms interchange and then by a Regenerator Reboiler (not shown) within the amine Regenerator 54. The concentrated acid gas leaving the Amine Regenerator 54 overhead system is recycled to AGCU 1 upstream of the Claus Reactor 28 via line 56, which connects to line 30. The stripped solvent, or lean amine, is cooled, filtered, and then recycled back to the top of the Absorber 48.

The amine circulation for the AGCU 1 is increased compared to a conventional SRU-TGTU approach. This additional circulation is required due to the reduced recovery in the Claus catalytic section of the unit (single stage). Despite the minor increase in size of to the amine exchangers and pumps, this is offset by the substantial savings in the Claus Catalytic section of the unit.

### Incineration

The overhead streams from the Absorber flows to the Incinerator 51. The relative size of the Incinerator 51 is unchanged from a traditional SRU-TGTU concept.

### Preferred Embodiments

There are four preferred embodiments to this method and consolidated apparatus for the recovery of sulfur from acid gases. The various embodiments reflect the usefulness of the process over a wide range of application in the oil & gas industry with selection of the optimum embodiment for a given application being dependent on the composition of the acid gases. The AGCU 1 approach as described
Very Lean Acid Gases with Contaminants
Very Lean Acid Gases without Contaminants
Moderately Lean Acid Gases
Refinery Acid Gases
   Recovery of Sulfur from Very Lean Acid Gases with Contaminants

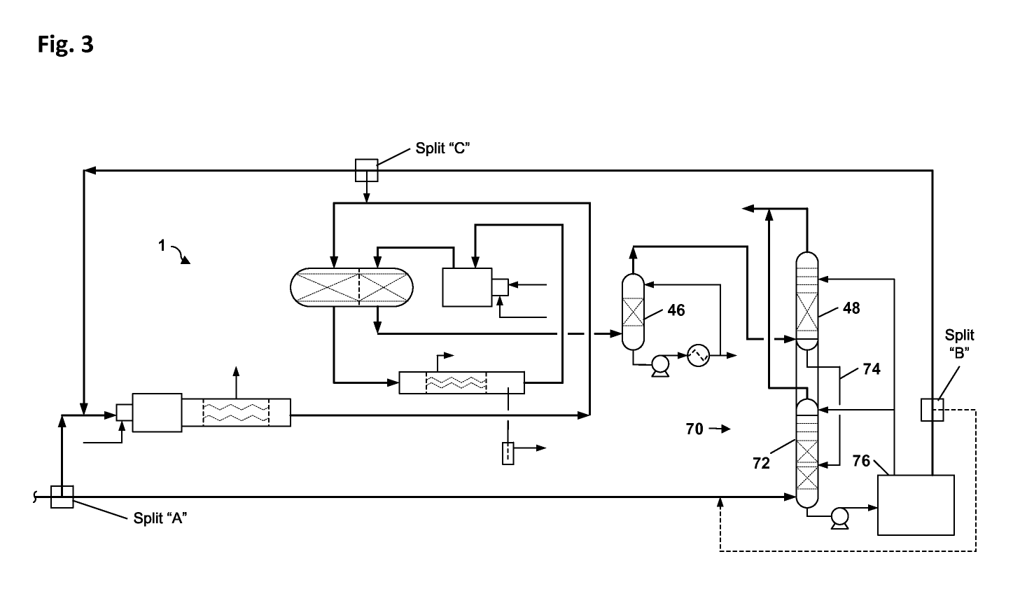

As shown in FIG. 3, the AGCU 1 with integrated Acid Gas Enrichment Unit (AGE) 70 is an effective way to achieve enrichment and sulfur recovery in a single consolidated unit. The semi-rich amine from the tail gas Absorber 48 is cascaded to an AGE Absorber 72 via line 74 to achieve the lowest possible total amine circulation rate. A common amine regeneration section 76 is employed for maximum equipment consolidation and lowest capital investment. The acid gas concentration is typically increased to at least 20% H₂S in this arrangement.

The typical approach to acid gas enrichment enriches the entire acid gas feed stream and then routes the entire regenerated/enriched acid gas to the front of the Claus unit as previously described. The AGCU 1 offers several different means which improve furnace temperature and increase contaminant destruction, while decreasing the size of the enrichment and regeneration sections. These different means are described below:
1. The bulk of the feed contaminants slip through the AGE Absorber 72 because the tower operates at low pressure and most contaminants are limited by their physical solubility. This means that the regenerated acid gas is relatively free of contaminants. This enables the recycle acid gas to be routed to the Claus Reactor 28 instead of to the Thermal Reactor 12. This is analogous to split-flow operation and can significantly increase the Thermal Reactor 12 combustion temperature. If the entire feed stream is enriched, then the fraction to the Claus Reactor 28 is limited to 60%.
2. For acid gas streams that require only a small amount of enrichment (feed contains 10 to 20% H₂S) only a portion of the feed acid gas is enriched. The higher the H₂S content of the feed, the lesser the degree of enrichment required, and the smaller the quantity of acid gas that must be enriched. The major advantage of this arrangement is the size reduction of the AGE 70 and the regeneration equipment, as well as the reduced steam demand in the Regenerator Reboiler.
3. For extremely lean acid gases (<10% H₂S) the extent of enrichment can be increased beyond the normal enrichment process by recycling a portion of the recycle acid gas to the front of the AGE Absorber 72. The lower the H₂S content of the feed, the higher the quantity of recycle that is required.

Together, the above means offer a great deal of flexibility in both process design and actual unit operation. The various AGCU/AGE flow arrangements are especially adept at treating acid gas feeds with varying feed content. An AGCU 1 can be designed for a particular “worst case” H₂S content and contaminant level, and then operated at the minimum enrichment fraction to produce the desired combustion temperature. This lowers the operating costs for off-design cases.

TABLE 1
Sample Flow Distributions for AGCU with Integrated AGE, Contaminated Feed (see FIG. 3)

| | | Acid Gas Distribution Splits | | | |
|---|---|---|---|---|---|
| Line | | (%, see Legend below) | | | |
| No. | % H₂S | “A” | “B” | “C” | Comments |
| 1 | 2 | 100 | 50 | 40 (min) | AGE with AG recycle to front of AGE Absorber |
| 2 | 5 | 100 | 25 | 40 (min) | AGE with AG recycle to front of AGE Absorber |
| 3 | 10 | 100 | 0 | 100 | Conventional AGE arrangement |
| 4 | 10 | 100 | 0 | 40-100 | Similar to conventional AGE arrangement, but |
| | | | | | adds “split-flow” to increase Furnace |
| | | | | | temperature |
| 5 | 10-20 | 0 < A < 100 | 0 | C = f (A) | Partial enrichment; values of “A” & “C” must |
| | | | | | insure a reducing environment in Furnace |
| | | | | | (zero free O₂); vary “A” to achieve desired |
| | | | | | combustion temperature |
| 6 | >20% | NA | NA | 0 | AGE not required |

Table Legend:
Split A - Percent Feed Acid Gas to AGE
Split B - Percent Recycle Acid Gas to AGE
Split C - Percent Recycle Acid Gas to Thermal Reactor

Recovery of Sulfur from Very Lean Acid Gases without Contaminants

Acid gases derived from syngas treating are common in gasification and coal-to-methanol facilities. They typically are very lean, have a high CO₂/CO/H₂ content, and have very few contaminants (>C4+). In these types of units, a reducing gas mixture (H₂ and CO) is usually available for tail gas hydrogenation. Usually, there is also a source of relatively pure oxygen that is used in the upstream syngas process.

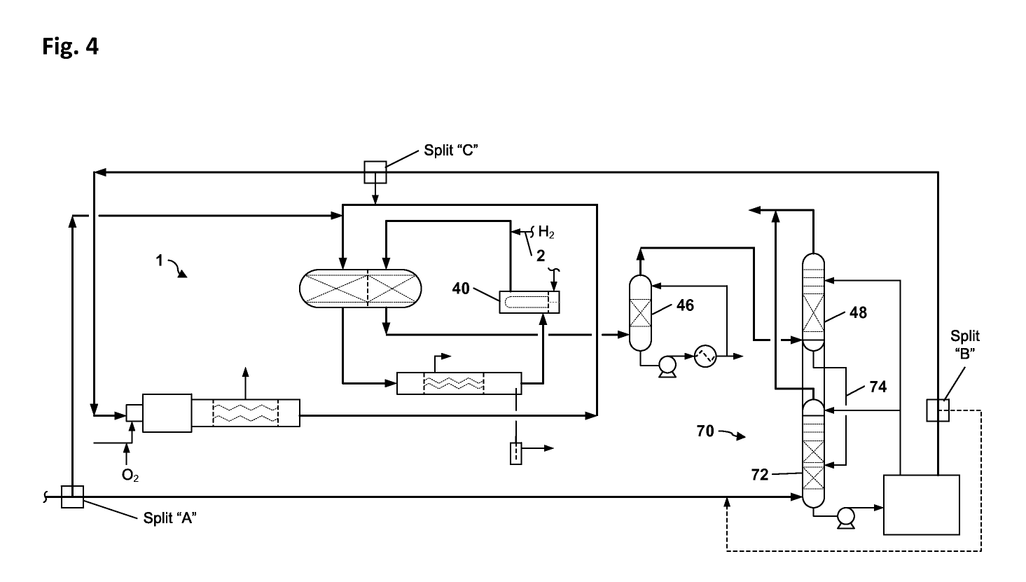

The AGCU 1 with integrated AGE 70 is an effective way to achieve enrichment and sulfur recovery in a single consolidated unit (FIG. 4). The arrangement is very similar to FIG. 3. However, in this application, the Reducing Gas Generator 36 can be replaced with a Steam Heater 40 and a supply of reducing gas 2. Oxygen enrichment has also been added to increase the combustion temperature. Since the acid gas is contaminant-free, the minimum required combustion temperature is 1800 F and split-flow operation is permitted.

The major difference between the two arrangements (FIGS. 3 and 4) is the distribution of the feed acid gas. In FIG. 4, the gas is split between the AGE 70 and the inlet to the Claus Reactor 28. This allows routing lean acid to the Claus Reactor 28 and rich acid gas to the Burner 11. The same three means for operating the previous embodiment may be applied to this embodiment.

TABLE 2
Sample Flow Distributions for AGCU with Integrated AGE, “Clean” Feed (see FIG. 4)

| | | Acid Gas Distribution Splits | | | |
|---|---|---|---|---|---|
| Line | | (%, see Legend below) | | | |
| No. | % H₂S | “A” | “B” | “C” | Comments |
| 1 | 2 | 100 | 50 | 40 (min) | AGE with AG recycle to front of AGE Absorber |
| 2 | 5 | 100 | 25 | 40 (min) | AGE with AG recycle to front of AGE Absorber |
| 3 | 10 | 100 | 0 | 100 | Conventional AGE arrangement |
| 4 | 10 | 100 | 0 | 40-100 | Similar to conventional AGE arrangement, but |
| | | | | | adds “split-flow” to increase Furnace |
| | | | | | temperature |
| 5 | 10-20 | 20 < A < | 0 | C = f (A) | Partial enrichment; values of “A” & “C” must |
| | | 100 | | | insure a reducing environment in Furnace |
| | | | | | (zero free O₂), vary “A” to achieve 1800 F |
| 6 | >20% | NA | NA | 0 | AGE not required |

Table Legend:
Split A - Percent Feed Acid Gas to AGE
Split B - Percent Recycle Acid Gas to AGE
Split C - Percent Recycle Acid Gas to Thermal Reactor

Recovery of Sulfur from Moderately Lean Acid Gases

The acid gases produced from sour gas processing often contain a moderately low concentration of H₂S and fairly high CO₂. SRU flame stability may become a problem at these conditions, even with acid gas and air preheat. The AGCU 1 is particularly well-suited for these applications. The AGCU 1 recycle of acid gas from the Amine Regenerator 54 to the Claus Reactor 28 results in a higher thermal stage flame temperature. All of the feed acid gas containing potential impurities is sent to the Burner 11, with only the relatively contaminant-free recycle stream bypassing the thermal stage. With the recycle routed to the Claus Reactor 28, the AGCU 1 has the benefit of both increased thermal reactor temperature and longer residence times, both of which improve the BTEX destruction. As seen in Table 3, the moderately lean acid gases show the greatest thermal stage temperature improvement.

COS and CS₂ formation in the thermal stage is another concern in these facilities as it can reduce the overall sulfur recovery efficiency. COS formation is generally attributed to high CO concentrations (CO production is principally formed from the dissociation of CO₂ in the Thermal Reactor) and CS₂ is believed to be related to the quantity of hydrocarbon in the acid gas. While some COS and CS₂ production will occur whenever CO₂ and hydrocarbons are present in the feed, the relative amounts of these two components are dependent on the temperature and residence time in the Thermal Reactor. Higher temperature and residence times both aid in the hydrolysis of COS and CS₂ in the Thermal Reactor. The AGCU recycle of acid gas from the regenerator to the Claus Reactor improves both of these parameters. This can reduce the production of both COS and CS₂ by as much as 10% each as seen in Table 4.

Recovery of Sulfur from Refinery Acid Gases

While sulfur recovery units in refineries often have rich acid gas H₂S concentrations, they also have their own set of unique challenges including NH₃ and hydrocarbon contaminants, stringent redundancy requirements, and limited plot space.

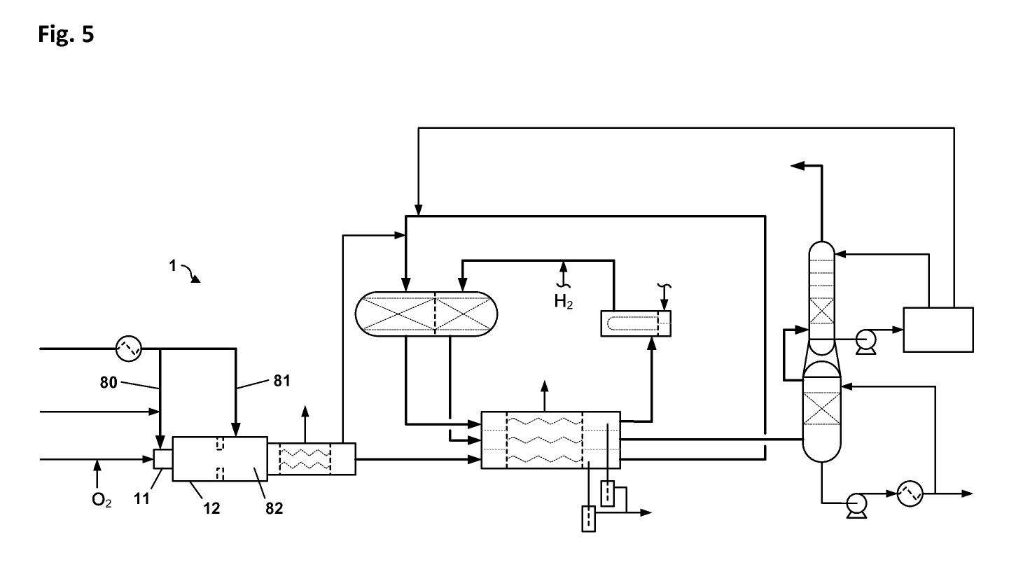

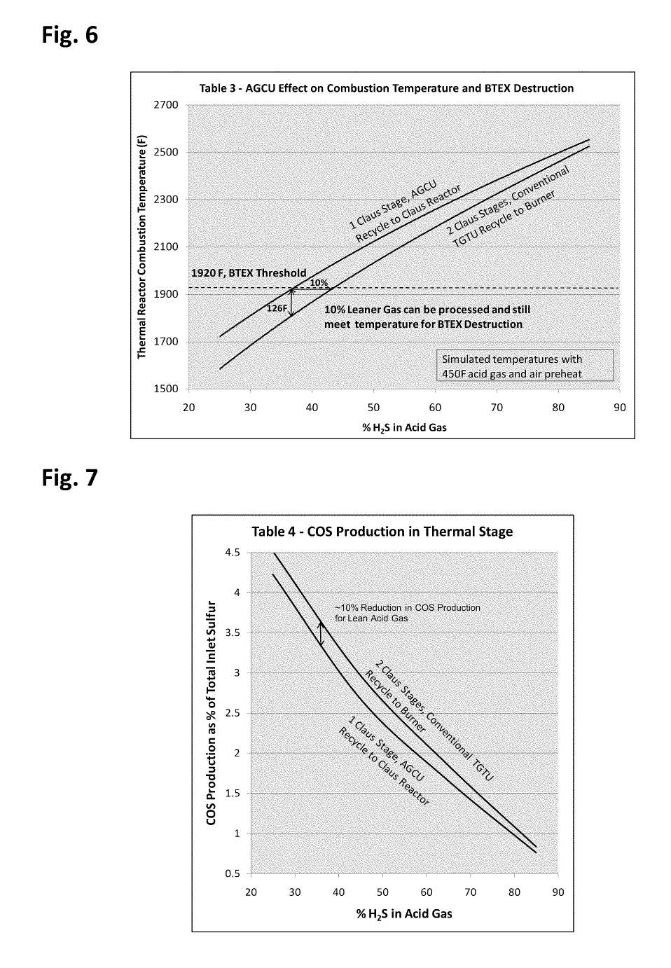

In refinery applications, the difficult feed contaminants include NH₃ and hydrocarbons. In addition to amine acid gas, refinery SRUs normally process a Sour Water Stripper (SWS) acid gas containing NH₃ and sometimes HCN. The minimum Thermal Reactor 12 temperature required to destroy NH₃ is 2300 F. This is typically accomplished by routing all the ammonia-bearing SWS acid gas via line 80 to the Burner 11 and bypassing a portion of the amine acid gas via line 81 to a Second Zone 82 of the Thermal Reactor 12. However, if the amine acid gas contains even small quantities of NH₃ or hydrocarbon, this can become a problem as the bypassed contaminants are not destroyed and can cause operating problems in downstream equipment. Recycling regenerator acid gas to the Claus Reactor 28 overcomes this potential problem, allowing more inlet amine acid gas to be routed to the Burner 11 via line 80 for contaminant destruction and a higher Thermal Reactor temperature as shown in FIG. 5.

Oxygen enrichment is often considered as part of the redundancy strategy and the AGCU is well-suited for oxygen-use. A common philosophy is to normally operate the Claus Thermal Section 28 of the AGCU 1 trains on air only, but design for oxygen enrichment operation when one of the trains is out of service. When oxygen is substituted for some or all of the combustion air in the AGCU 1, the amount of inert nitrogen is reduced in the process gas. This permits additional acid gas to be processed within the same mechanical envelope. The oxygen-enriched AGCU 1 offers the lowest CAPEX for refinery sulfur recovery.

### Additional Note

Many changes and modifications will occur to those skilled in the art upon studying this disclosure. All such changes and modifications that fall within the spirit of this invention are intended to be included within its scope as defined by the appended claims.

What is claimed and desired to be secured by Letters Patent is as follows:

1. A method and consolidated apparatus for the recovery of sulfur from acid gases, the method comprising:
a. Claus Thermal Reaction section for combusting one-third of the acid gas H₂S to SO₂ and thermally promoting the Claus Reaction;
b. Claus Catalytic Reaction section for catalytically continuing the Claus Reaction and recovering the produced sulfur;
c. Hydrogenation section for generating reducing gas and hydrogenating the tail gas from the Claus Reaction section;
d. Quench section for cooling the hydrogenated tail gas;
e. Amine section for recovering the H₂S from the quenched tail gas; and
f. Incineration section for incinerating the tail gases prior to discharge to the atmosphere.

2. The method of claim 1 wherein all the acid gas generated from the Amine section is routed to the inlet of the Claus Catalytic Reaction section

3. The method of claim 1 wherein a fraction of the acid gas generated from the Amine section is routed to the inlet of the Claus Catalytic Reaction section with the balance sent to the Claus Thermal Reaction Section

4. The method of claim 1 wherein the Quench section employs a Desuperheater in the inlet gas stream prior to the Quench Column

5. The method of claim 1 wherein the Absorber in the Amine section is comprised of a lower packed section and an upper section trayed section

6. The method of claim 1 wherein the Claus Catalytic Reaction section contains a single Claus Catalytic reactor

7. The method of claim 1 wherein an Acid Gas Enrichment section is added to the Amine section

8. The method of claim 1 wherein a fraction of the acid gas from the Amine section is routed to the inlet of the Acid Gas Enrichment section and the balance sent to a combination of the Claus Thermal Reaction section and the Claus Catalytic Reaction section

9. The method of claim 1 wherein the energy recovery of the Claus Thermal Reaction section is optimized with respect to the Claus Catalytic Reaction section

10. The method of claim 1 wherein the individual equipment services are combined into the maximum number of shared shells.
